(19) United States
(12) Patent Application Publication
(10) Pub. No.: US 2023/0304697 A1
(43) Pub. Date: Sep. 28, 2023

(54) ELECTRICAL ENCLOSURE ASSEMBLY FOR HVAC SYSTEM

(71) Applicant: Johnson Controls Tyco IP Holdings LLP, Milwaukee, WI (US)

(72) Inventors: Michael Scott Todd, Jacobus, PA (US); Scott Victor Slothower, Dillsburg, PA (US); Ajit Wasant Kane, York, PA (US); Jonathan Eugene Kunkle, Hanover, PA (US); Kanishk Dubey, York, PA (US); Karl Richard Barley, York, PA (US)

(21) Appl. No.: 18/024,233

(22) PCT Filed: Sep. 1, 2021
(86) PCT No.: PCT/US2021/048740

§ 371 Date: Mar. 1, 2023

Related U.S. Application Data
(60) Provisional application No. 63/073,303, filed on Sep. 1, 2020.

(51) Int. Cl. F24F 11/88; F24F 13/20

(52) U.S. Cl. CPC F24F 11/88; F24F 13/20

(57) ABSTRACT

A heating, ventilation, and/or air conditioning (HVAC) system includes a first electrical enclosure that has a main drive line variable speed drive (VSD) configured to drive operation of a compressor motor of the HVAC system and a second electrical enclosure that has a power distribution component. The power distribution component is configured to receive electrical power from a power source and to supply the electrical power to the main drive line VSD.

### CROSS REFERENCE TO RELATED APPLICATION

This application claims priority to and the benefit of U.S. Provisional Patent Application Ser. No. 63/073,303, entitled “ELECTRICAL ENCLOSURE ASSEMBLY FOR HVAC SYSTEM,” filed Sep. 1, 2020, which is hereby incorporated by reference in its entirety for all purposes.

### BACKGROUND

This section is intended to introduce the reader to various aspects of art that may be related to various aspects of the present disclosure, which are described below. This discussion is believed to be helpful in providing the reader with background information to facilitate a better understanding of the various aspects of the present disclosure. Accordingly, it should be noted that these statements are to be read in this light, and not as admissions of prior art.

Chiller systems, or vapor compression systems, utilize a working fluid (e.g., a refrigerant) that changes phases between vapor, liquid, and combinations thereof, in response to exposure to different temperatures and pressures within components of the chiller system. A chiller system may place the working fluid in a heat exchange relationship with a conditioning fluid (e.g., water) and may deliver the conditioning fluid to conditioning equipment and/or a conditioned environment serviced by the chiller system. In such applications, the conditioning fluid may be passed through downstream equipment, such as air handlers, to condition other fluids, such as air in a building. The chiller system may also include an enclosure (e.g., electrical enclosure) in which various components, such as electrical components (e.g., wiring, a motor drive), are disposed. Unfortunately, it may be difficult and/or costly to manufacture the enclosure for different chiller systems. For example, different chiller systems may have different sets of components to be housed by the enclosure. Entirely different enclosures may be manufactured to accommodate the components in different chiller systems.

### SUMMARY

A summary of certain embodiments disclosed herein is set forth below. It should be noted that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a heating, ventilation, and/or air conditioning (HVAC) system includes a first electrical enclosure that has a main drive line variable speed drive (VSD) configured to drive operation of a compressor motor of the HVAC system and a second electrical enclosure that has a power distribution component. The power distribution component is configured to receive electrical power from a power source and to supply the electrical power to the main drive line VSD.

In an embodiment, a heating, ventilation, and/or air conditioning (HVAC) system includes a first electrical enclosure that has a main drive line variable speed drive (VSD) disposed therein and configured to operate a compressor motor of the HVAC system. The first electrical enclosure is configured for implementation with different configurations of the HVAC system. The HVAC system also includes a second electrical enclosure that has a power distribution component configured to receive electrical power and to provide the electrical power to the main drive line VSD to enable operation of the main drive line VSD. The second electrical enclosure is selected from a plurality of second enclosure embodiments.

In an embodiment, a In an embodiment, a heating, ventilation, and/or air conditioning (HVAC) system includes a first electrical enclosure configured to enclose a main drive line variable speed drive (VSD) configured to drive operation of a compressor motor of the HVAC system, a second electrical enclosure configured to enclose a power distribution component configured to receive electrical power and to supply the electrical power to the main drive line VSD to operate the compressor motor, and a third electrical enclosure configured to enclose a filter configured to filter the electrical power and mitigate harmonics of the electrical power before the electrical power is supplied to the main drive line VSD.

### DRAWINGS

Various aspects of this disclosure may be better understood upon reading the following detailed description and upon reference to the drawings in which:

FIG. 1 is a perspective view of a building that may utilize an embodiment of a heating, ventilation, and/or air conditioning (HVAC) system in a commercial setting, in accordance with an aspect of the present disclosure;

FIG. 2 is a schematic of an embodiment of a vapor compression system, in accordance with an aspect of the present disclosure;

FIG. 3 is a schematic of an embodiment of an HVAC system with an electrical enclosure assembly having multiple electrical enclosures, in accordance with an aspect of the present disclosure;

FIG. 4 is a front view of an embodiment of an HVAC system with an electrical enclosure assembly having multiple electrical enclosures, in accordance with an aspect of the present disclosure; and

FIG. 5 is a side view embodiment of an HVAC system with an electrical enclosure assembly having multiple electrical enclosures, in accordance with an aspect of the present disclosure.

### DETAILED DESCRIPTION

One or more specific embodiments will be described below. In an effort to provide a concise description of these embodiments, not all features of an actual implementation are described in the specification. It should be noted that in the development of any such actual implementation, as in any engineering or design project, numerous implementation-specific decisions must be made to achieve the developers' specific goals, such as compliance with system-related and business-related constraints, which may vary from one implementation to another. Moreover, it should be noted that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be noted that references to “one embodiment” or “an embodiment” of the present disclosure are not intended to be interpreted as excluding the existence of additional embodiments that also incorporate the recited features.

Embodiments of the present disclosure relate to a heating, ventilation, and/or air conditioning (HVAC) system, such as a chiller system. The HVAC system may include a vapor compression system through which a refrigerant is directed in order to heat and/or cool a conditioning fluid. As an example, the vapor compression system may include a compressor configured to pressurize the refrigerant and to direct the pressurized refrigerant to a condenser configured to cool the pressurized refrigerant. An evaporator of the vapor compression system may receive the cooled refrigerant and may place the cooled refrigerant in a heat exchange relationship with the conditioning fluid to absorb thermal energy or heat from the conditioning fluid, thereby cooling the conditioning fluid. The HVAC system may also include an electrical enclosure to house various components, such as electrical components of the vapor compression system, and shield the components from an ambient environment. As used herein, an electrical enclosure refers to a physical housing suitable for (e.g., configured to, designed to) enclosing electrical components, such as a physical housing having a certain moisture rating, being manufactured from a particular type or class of material, enabling an amount of heat transfer with the ambient environment, and so forth. For example, the electrical enclosure housing electrical components may include components that receive power (e.g., electrical power) from a power source and utilize the power to control operation of a motor to operate the compressor and cool the conditioning fluid. Additional electrical components disposed within an electrical enclosure may include power distribution components, control panels, cooling systems, and so forth.

Different HVAC systems may include different components that may be disposed within the respective electrical enclosures. For instance, each HVAC system may include a different or particular set of components to convert electrical power for supply to subsystems of the HVAC system, such as a compressor motor. Indeed, such components may have different sizes, configurations, layouts, couplings, and so forth, and may therefore occupy differently sized spaces and/or footprints. As such, the respective electrical enclosure of each HVAC system may be specifically sized, arranged, or otherwise manufactured in order to accommodate the specific components of the HVAC system. By way of example, the electrical enclosure may be manufactured to enable the components to be specifically positioned relative to one another within the electrical enclosure based on the quantity, size, and/or type of the components, thereby increasing complexity of manufacturing each HVAC system.

Thus, it is presently recognized that there is a need to improve the manufacture of the electrical enclosures for different HVAC systems. Accordingly, embodiments of the present disclosure are directed to an HVAC system having multiple electrical enclosures, and each electrical enclosure may accommodate a different set of components. For example, each HVAC system may include a set of common components, or components that may be commonly used in other HVAC system embodiments, and a main electrical enclosure may be manufactured or assembled to house such common components. In other words, the same or substantially the same embodiment of the main electrical enclosure may be used with different HVAC system embodiments.

Moreover, a separate, additional electrical enclosure may be manufactured or assembled to accommodate components that may not be commonly used in other HVAC systems (e.g., optional components, application-specific components). That is, the additional electrical enclosure may be sized or otherwise manufactured based on the components that are specific to the HVAC system in which the additional electrical enclosure is implemented. As such, instead of using a single (e.g., larger) electrical enclosure that houses both common and specific components, in which an entirety of the single electrical enclosure may be different from the electrical enclosure of other HVAC system embodiments, different embodiments of HVAC systems may each include a common main electrical enclosure (e.g., a main electrical enclosure having a standard size) for housing the common components and also or optionally include an additional electrical enclosure for housing the specific components implemented with a particular HVAC system. In other words, the additional electrical enclosure may be particularly selected for each HVAC system (e.g., based on the additional or specific components implemented with the HVAC system), while the common main electrical enclosure may be utilized with a variety of HVAC systems. Indeed, the common main electrical enclosure for housing common or standard components may be smaller than electrical enclosures traditionally used with HVAC systems (e.g., for housing both common and specific components) and may be manufactured in large quantities, and additional electrical enclosures for housing optional or non-standard components may be tailored for the particular components and/or HVAC system embodiment with which it is to be utilized. In this way, manufacturing costs may be reduced, and configurability of the various HVAC system embodiments may be improved.

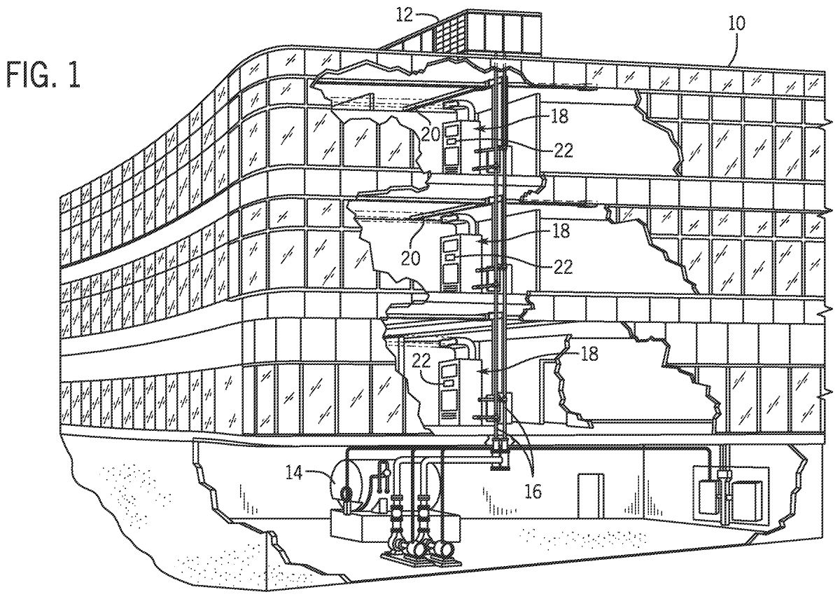

Turning now to the drawings, FIG. 1 is a perspective view of an embodiment of an application for a heating, ventilation, and air conditioning (HVAC) system. Such systems, in general, may be applied in a range of settings, both within the HVAC field and outside of that field. The HVAC systems may provide cooling to data centers, electrical devices, freezers, coolers, or other environments through vapor compression refrigeration, absorption refrigeration, or thermoelectric cooling. In presently contemplated applications, however, HVAC systems may be used in residential, commercial, light industrial, industrial, and in any other application for heating or cooling a volume or enclosure, such as a residence, building, structure, and so forth. Moreover, the HVAC systems may be used in industrial applications, where appropriate, for basic cooling and heating of various fluids.

The illustrated embodiment shows an HVAC system for building environmental management that may utilize heat exchangers. A building 10 is cooled by a system that includes a chiller 12 and a boiler 14. As shown, the chiller 12 is disposed on the roof of building 10, and the boiler 14 is located in the basement; however, the chiller 12 and boiler 14 may be located in other equipment rooms or areas next to the building 10. The chiller 12 may be an air cooled or water cooled device that implements a refrigeration cycle to cool water or other conditioning fluid. The chiller 12 is housed within a structure that includes a refrigeration circuit, a free cooling system, and associated equipment such as pumps, valves, and piping. For example, the chiller 12 may be single package rooftop unit that incorporates a free cooling system. The boiler 14 is a closed vessel in which water is heated. The water from the chiller 12 and the boiler 14 is circulated through the building 10 by water conduits 16. The water conduits 16 are routed to air handlers 18 located on individual floors and within sections of the building 10.

The air handlers 18 are coupled to ductwork 20 that is adapted to distribute air between the air handlers 18 and may receive air from an outside intake (not shown). The air handlers 18 include heat exchangers that circulate cold water from the chiller 12 and hot water from the boiler 14 to provide heated or cooled air to conditioned spaces within the building 10. Fans within the air handlers 18 draw air through the heat exchangers and direct the conditioned air to environments within building 10, such as rooms, apartments, or offices, to maintain the environments at a designated temperature. A control device 22, shown here as including a thermostat, may be used to designate the temperature of the conditioned air. The control device 22 also may be used to control the flow of air through and from the air handlers 18. Other devices may be included in the system, such as control valves that regulate the flow of water and pressure and/or temperature transducers or switches that sense the temperatures and pressures of the water, the air, and so forth. Moreover, control devices 22 may include computer systems that are integrated with or separate from other building control or monitoring systems, and even systems that are remote from the building 10.

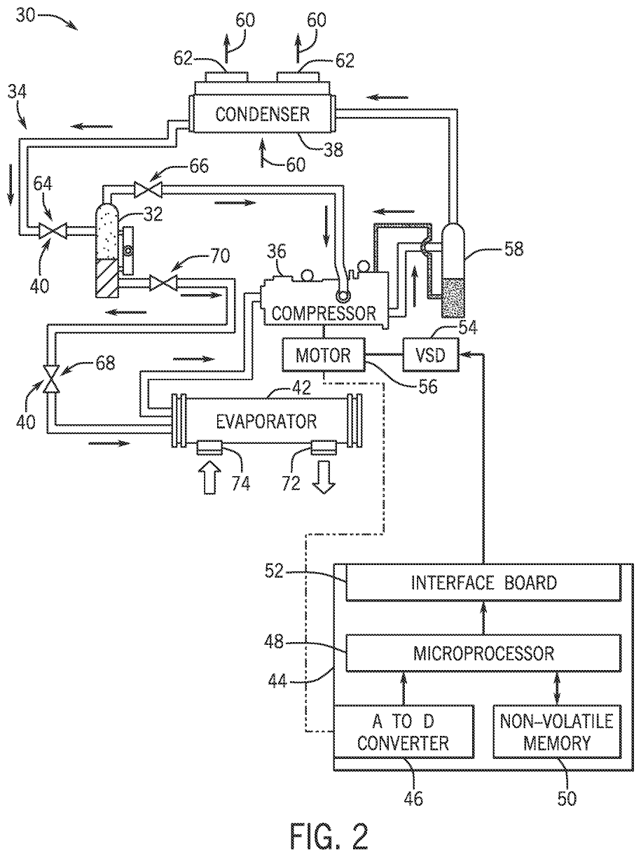

FIG. 2 is a schematic of an embodiment of a vapor compression system 30 having a flash tank 32 (e.g., economizer tank). For example, the vapor compression system 30 may be a part of an air-cooled chiller. However, it should be noted that the disclosed techniques may be incorporated with a variety of other types of chillers. The vapor compression system 30 includes a refrigerant circuit 34 configured to circulate a working fluid, such as refrigerant, therethrough with a compressor 36 (e.g., a screw compressor) disposed along the refrigerant circuit 34. The refrigerant circuit 34 also includes the flash tank 32, a condenser 38, expansion valves or devices 40, and a liquid chiller or an evaporator 42. The components of the refrigerant circuit 34 enable heat transfer between the working fluid and other fluids (e.g., a conditioning fluid, air, water, etc.) in order to provide cooling to an environment, such as an interior of the building 10.

Some examples of working fluids that may be used as refrigerants in the vapor compression system 30 are hydrofluorocarbon (HFC) based refrigerants, for example, R-410A, R-407, R-134a, hydrofluoro-olefin (HFO), “natural” refrigerants like ammonia (NH3), R-717, carbon dioxide (CO2), R-744, or hydrocarbon based refrigerants, water vapor, refrigerants with low global warming potential (GWP), or any other suitable refrigerant. In some embodiments, the vapor compression system 30 may be configured to efficiently utilize refrigerants having a normal boiling point of about 19 degrees Celsius (66 degrees Fahrenheit or less) at one atmosphere of pressure, also referred to as low pressure refrigerants, versus a medium pressure refrigerant, such as R-134a. As used herein, “normal boiling point” may refer to a boiling point temperature measured at one atmosphere of pressure.

The vapor compression system 30 may further include a control panel 44 (e.g., controller) that has an analog to digital (A/D) converter 46, a microprocessor 48, a non-volatile memory 50, and/or an interface board 52. In some embodiments, the vapor compression system 30 may use one or more of a variable speed drive (VSDs) 54 and a motor 56. The motor 56 may drive the compressor 36 and may be powered by the VSD 54. The VSD 54 receives alternating current (AC) power having a particular fixed line voltage and fixed line frequency from an AC power source, and provides power having a variable voltage and frequency to the motor 56. In other embodiments, the motor 56 may be powered directly from an AC or direct current (DC) power source. The motor 56 may include any type of electric motor that can be powered by the VSD 54 or directly from an AC or DC power source, such as a switched reluctance motor, an induction motor, an electronically commutated permanent magnet motor, or another suitable motor.

The compressor 36 compresses a refrigerant vapor and may deliver the vapor to an oil separator 58 that separates oil from the refrigerant vapor. The refrigerant vapor is then directed toward the condenser 38, and the oil is returned to the compressor 36. The refrigerant vapor delivered to the condenser 38 may transfer heat to a cooling fluid at the condenser 38. For example, the cooling fluid may be ambient air 60 forced across heat exchanger coils of the condenser 38 by condenser fans 62. The refrigerant vapor may condense to a refrigerant liquid in the condenser 38 as a result of thermal heat transfer with the cooling fluid (e.g., the ambient air 60).

The liquid refrigerant exits the condenser 38 and then flows through a first expansion device 64 (e.g., expansion device 40, electronic expansion valve, etc.). The first expansion device 64 may be a flash tank feed valve configured to control flow of the liquid refrigerant to the flash tank 32. The first expansion device 64 is also configured to lower the pressure of (e.g., expand) the liquid refrigerant received from the condenser 38. During the expansion process, a portion of the liquid may vaporize, and thus, the flash tank 32 may be used to separate the vapor from the liquid received from the first expansion device 64. Additionally, the flash tank 32 may provide for further expansion of the liquid refrigerant because of a pressure drop experienced by the liquid refrigerant when entering the flash tank 32 (e.g., due to a rapid increase in volume experienced when entering the flash tank 32).

The vapor in the flash tank 32 may exit and flow to the compressor 36. For example, the vapor may be drawn to an intermediate stage or discharge stage of the compressor 36 (e.g., not the suction stage). A valve 66 (e.g., economizer valve, solenoid valve, etc.) may be included in the refrigerant circuit 34 to control flow of the vapor refrigerant from the flash tank 32 to the compressor 36. In some embodiments, when the valve 66 is open (e.g., fully open), additional liquid refrigerant within the flash tank 32 may vaporize and provide additional subcooling of the liquid refrigerant within the flash tank 32. The liquid refrigerant that collects in the flash tank 32 may be at a lower enthalpy than the liquid refrigerant exiting the condenser 38 because of the expansion in the first expansion device 64 and/or the flash tank 32. The liquid refrigerant may flow from the flash tank 32, through a second expansion device 68 (e.g., expansion device 40, an orifice, etc.), and to the evaporator 42. In some embodiments, the refrigerant circuit 34 may also include a valve 70 (e.g., drain valve) configured to regulate flow of liquid refrigerant from the flash tank 32 to the evaporator 42. For example, the valve 70 may be controlled (e.g., via the control panel 44) based on an amount of suction superheat of the refrigerant.

The liquid refrigerant delivered to the evaporator 42 may absorb heat from a conditioning fluid, which may or may not be the same cooling fluid used in the condenser 38. The liquid refrigerant in the evaporator 42 may undergo a phase change to become vapor refrigerant. For example, the evaporator 42 may include a tube bundle fluidly coupled to a supply line 72 and a return line 74 that are connected to a cooling load. The conditioning fluid of the evaporator 42 (e.g., water, oil, calcium chloride brine, sodium chloride brine, or any other suitable fluid) enters the evaporator 42 via the return line 74 and exits the evaporator 42 the via supply line 72. The evaporator 42 may reduce the temperature of the conditioning fluid in the tube bundle via thermal heat transfer with the refrigerant so that the conditioning fluid may be utilized to provide cooling for a conditioned environment. The tube bundle in the evaporator 42 can include a plurality of tubes and/or a plurality of tube bundles. In any case, the refrigerant vapor exits the evaporator 42 and returns to the compressor 36 by a suction line to complete the refrigerant cycle.

In some circumstances, an HVAC system may have one or more electrical enclosures configured to house various electrical components and block exposure of such components to an ambient environment. For example, the HVAC system may include a main electrical enclosure configured to accommodate certain electrical components that are similar to other electrical components used in other HVAC systems (e.g., different embodiments of HVAC systems) Thus, the same embodiment of the main electrical enclosure may be used for housing such components in different HVAC systems. The HVAC system may also include an additional (e.g., a secondary) electrical enclosure configured to accommodate additional electrical components that are different than components used in other HVAC systems. That is, the additional electrical enclosure may house components specific to the HVAC system in which the additional electrical enclosure is implemented, and the additional electrical enclosure may therefore be of a specific embodiment. In this manner, for HVAC systems having different components (e.g., having a set of similar components and another set of different components), the same embodiment of the main electrical enclosure and different embodiments of the additional electrical enclosure may be used.

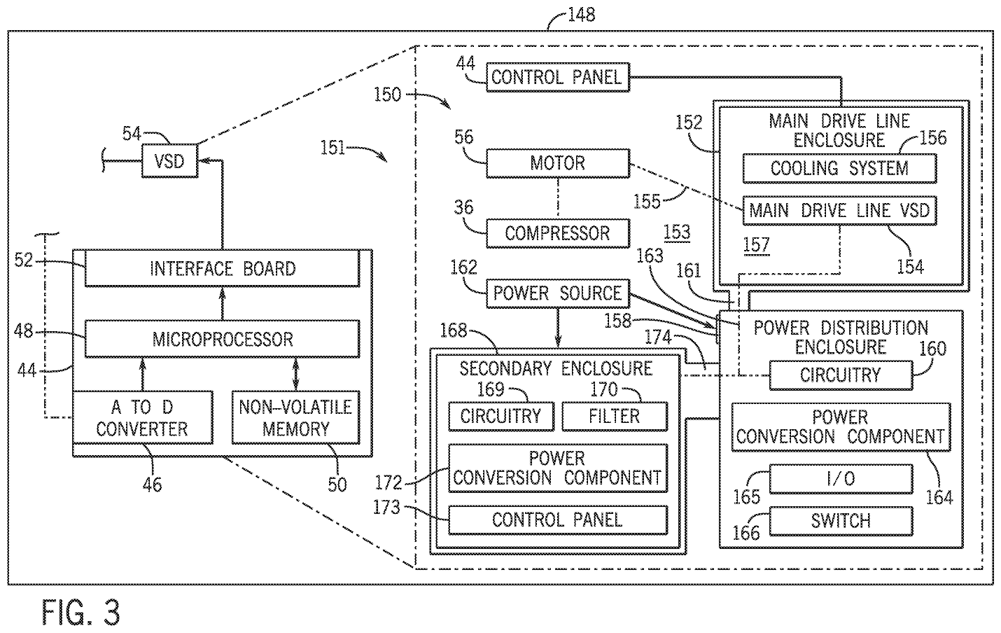

With this in mind, FIG. 3 is a schematic of an embodiment of an electrical enclosure assembly 150 that may be implemented in an HVAC system 151 (e.g., a chiller system). For example, the HVAC system 151 may include a main housing or support structure 148, which may be configured to enclose or support multiple components of the vapor compression system 30. For example, the main housing 148 may enclose and/or support the compressor 36, the condenser 38, the evaporator 42, the motor 56, and so forth. The main housing 148 may also enclose or support multiple enclosures, such as the electrical enclosure assembly 150. For example, the electrical enclosure assembly 150 may be attached or secured to the main housing 148, enclosed by the main housing 148, or otherwise be associated with the main housing 148.

Although the illustrated HVAC system 151 may be an air-cooled chiller system in which the electrical enclosure assembly 150 houses various components of the vapor compression system 30, the electrical enclosure assembly 150 may be implemented in any suitable HVAC system 151, such as a liquid-cooled chiller system, a direct expansion HVAC system, and so forth, to house any suitable components of the HVAC system 151. The electrical enclosure assembly 150 may include a main drive line enclosure 152 (e.g., an electrical enclosure, a first electrical enclosure) positioned within and/or supported by the main housing 148, and a main drive line VSD 154 (e.g., the VSD 52) may be disposed in the electrical enclosure assembly 150. During operation of the HVAC system 151 (e.g., of the vapor compression system 30), the main drive line VSD 154 may be configured to operate the motor 56 in order to drive the compressor 36 to pressurize the refrigerant of the vapor compression system 30. For instance, operation of the main drive line VSD 154 may cause the motor 56 to operate the compressor 36 in accordance to a particular operating parameter (e.g., a capacity, a frequency). In the illustrated embodiment, the compressor 36 and the motor 56 are internal to the main housing 148 and external to the main drive line enclosure 152. Indeed, certain components of the vapor compression system 30 may be positioned outside of the main drive line enclosure 152 (e.g., to circulate the refrigerant outside of the main drive line enclosure 152) and may be enclosed by the main housing 148 (e.g., to shield the compressor 36 and the motor 56 from external elements, such as debris). For example, electrical connectors 155 (e.g., wires, cables) may extend between an exterior 153 and an interior 157 of the main drive line enclosure 152 (e.g., within the main housing 148) in order to electrically and/or communicatively couple the motor 56 and the main drive line VSD 154 to one another.

The main drive line enclosure 152 may also contain a cooling system 156 configured to cool the main drive line VSD 154, thereby blocking the main drive line VSD 154 from overheating and improving the operation of the main drive line VSD 154. To this end, the cooling system 156 may place the main drive line VSD 154 in a heat exchange relationship with a cooling fluid that absorbs heat from the main drive line VSD 154 to cool the main drive line VSD 154. For example, the cooling system 156 may include a fan configured to draw or force air (e.g., ambient air) across the main drive line VSD 154 to cool the main drive line VSD 154 via convection. Additionally or alternatively, the cooling system 156 may direct a cooled liquid (e.g., water, glycol) through a circuit or other conduit to absorb heat from and cool the main drive line VSD 154.

Further still, the control panel 44 may be included within, coupled to, or otherwise associated with the main drive line enclosure 152. The control panel 44 may be communicatively coupled to a component (e.g., the main drive line VSD 154) of the HVAC system 151, and the control panel 44 may be configured to output a control signal to the component to operate the component. For instance, the control panel 44 may be accessible by a user (e.g., an operator, a technician, a resident), and the user may interact with the interface board 52 of the control panel 44 to transmit a user input, and the control panel 44 may transmit the control signal for operating various components of the HVAC system 151 based on the user input. Thus, the interface board 52 may include a feature (e.g., a touchscreen, a button, a switch, a dial, trackpad) with which the user may interact, and the control panel 44 may be arranged to enable user access to the control panel 44. For example, the control panel 44 may be coupled to an exterior panel of the main drive line enclosure 152, the main drive line enclosure 152 may have a movable component (e.g., a door, a cover, an access panel) configured to be transitioned to expose the interface board 52 to the user, and/or the control panel 44 and/or the main drive line enclosure 152 may be arranged in another suitable manner to facilitate user access of the control panel 44.

In certain embodiments, the same or substantially the same embodiment of the main drive line VSD 154 and/or the cooling system 156 may be used for similar HVAC systems 151, such as HVAC systems 151 of a similar size, HVAC systems 151 using a similar specification or type of components (e.g., the compressor 36), HVAC systems 151 installed for similar applications, and so forth. Indeed, the respective main drive line VSDs 154 and/or cooling systems 156 of similar HVAC systems 151 may be of substantially the same type (e.g., having the same specification), may occupy substantially the same spatial volume or footprint, may be positioned or oriented in substantially the same arrangement (e.g., relative to one another), and/or may have other similarities or common attributes. As such, the main drive line enclosure 152 may be of a common, standard, or universal embodiment in that the same embodiment of the main drive line enclosure 152 may be implemented in HVAC systems 151 that have certain similar characteristics or attributes with one another, yet have other differences compared to one another, such as different optional electrical equipment. Manufacture of a single embodiment of the main drive line enclosure 152 (e.g., in large quantities) that may be utilized with different HVAC systems 151 reduces the cost and/or complexity associated with manufacturing different HVAC systems 151.

The HVAC system 151 may also include a power distribution enclosure 158 (e.g., an electrical enclosure, a second electrical enclosure) disposed in and/or supported by the main housing 148 and configured to house various components that provide power to the main drive line VSD 154 in order to enable operation of the main drive line VSD 154. In the illustrated embodiment, the power distribution enclosure 158 includes power distribution components, such as circuitry 160 (e.g., wiring, circuits, etc.) configured to receive electrical power from a power source 162, such as a power grid, a battery, a solar panel, an electrical generator, a gas engine, another suitable power source that provides electrical power, or any combination thereof. The illustrated power distribution enclosure 158 does not include or enclose the power source 162, but additional or alternative power distribution enclosures 158 may house at least a portion of the power source 162. The circuitry 160 may electrically couple the power source 162 to the main drive line VSD 154 and/or to the cooling system 156. In some embodiments, the main drive line enclosure 152 may be physically coupled to the power distribution enclosure 158 in order to enable electrical coupling of the circuitry 160 and the main drive line VSD 154. For instance, a first connector 161, which may have a channel or conduit, may physically couple the main drive line enclosure 152 and the power distribution enclosure 158 to one another, and an electrical connector 163 may extend through the channel or conduit to electrically couple the main drive line VSD 154 to the power source 162 via the circuitry 160.

The power distribution enclosure 158 may further house additional components configured to facilitate supply of power to the main drive line VSD 154. Such additional components may include a power conversion component 164 (e.g., the A/D converter 46) configured to condition and/or change electrical power received from the power source 162 into a form that is usable by the main drive line VSD 154 and/or by the cooling system 156. For instance, the power conversion component 164 may include a rectifier, an inverter, a transformer, a voltage regulator, a chopper, a converter, another suitable component, or any combination thereof. Indeed, the power conversion component 164 may adjust the voltage type (e.g., between AC and DC power), the voltage value, the current type, the current value, a waveform, a phase, and so forth, of the electrical power received from the power source 162 to supply a suitable level of power to the main line VSD 154 and/or to the cooling system 156.

The power distribution enclosure 158 may also include an input/output (I/O) port 165 that may be used to send and/or receive data. For example, a computing device (e.g., a mobile phone, a tablet, a computer) may communicatively couple to one of the components of the HVAC system 151 to enable the computing device to transmit data (e.g., to control operation of a component of the HVAC system 151), such as based on a user input. The power distribution enclosure 158 may further include a switch 166 that is configured to block electrical power from being supplied to the main drive line VSD 154. For instance, the switch 166 may include a manual switch (e.g., operable via a user input and/or physical positioning), a fuse, a circuit breaker, another suitable component, or any combination thereof. The switch 166 may block electrical power supply to the main drive line VSD 154 by electrically decoupling the power source 162 from the main drive line VSD 154. As an example, based on the user input (e.g., transmitted via the computing device coupled via the I/O port 165) that may be a request to suspend or terminate operation of the main drive line VSD 154 and/or the HVAC system 151, the switch 166 may interrupt the electrical power supply to the main drive line VSD 154. As another example, the switch 166 may automatically block electrical power supply (e.g., without a user input) to the main drive line VSD 154 in response to a power surge, such as a sudden increase in current received from the power supply 162, thereby protecting the main drive line VSD 154 from the power surge.

A particular combination of the circuitry 160, the power conversion component 164, the I/O device 165, and/or the switch 166 may be employed based on the power source 162, the main drive line VSD 154, the compressor 36, input supply voltage specifications for the HVAC system 151, another factor, or any combination thereof. For example, different embodiments of the circuitry 160, the power conversion component 164, the I/O device 165, and/or the switch 166 may be utilized depending on various parameters and/or characteristics of the HVAC system 151. Different combinations and/or arrangements of such components may have different footprints and/or configurations for which different embodiments of the power distribution enclosure 158 may be utilized. To this end, different embodiments of the power distribution enclosure 158 may be manufactured and selected for implementation in a particular HVAC system 151 based on the type, number, arrangement, and so forth of the components to be contained within the power distribution enclosure 158 to operate the HVAC system 151 and/or a size or configuration of the main housing 148.

However, in some embodiments, a first power distribution enclosure 158 for a first HVAC system 151 may include embodiments of components that are similar to that of a second power distribution enclosure 158 for a second HVAC system 151. For example, the first and second HVAC systems 151 may use respective main drive line VSDs 154 of the same type, specification, or configuration, and may therefore utilize similar components in the respective power distribution enclosures 158 to provide power to the main drive line VSDs 154. Thus, while multiple preset or predetermined embodiments of the power distribution enclosure 158 may be manufactured, one of the preset embodiments may be selected for implementation in multiple HVAC systems 151 based on a particular configuration of the HVAC systems 151 (e.g., a size or configuration of the main housing 148) and/or a particular electrical power (e.g., having a specific input voltage) provided by the power source 162 to the HVAC systems 151. In this way, the power distribution enclosure 158 may also be of a common embodiment.

Additionally or alternatively, certain components included in the power distribution enclosure 158 may be specifically selected for a particular HVAC system 151, such as based on a particular application of the HVAC system 151 and/or a user or customer request for certain components to be implemented in the power distribution enclosure 158 and/or the HVAC system 151. That is, a specific or unique set of power distribution components may be implemented in the HVAC system 151, and the particular set of power distribution components may be different from power distribution components of other HVAC systems 151. For this reason, the power distribution enclosure 158 may additionally or alternatively be of a variable embodiment in that the configuration of the power distribution enclosure 158 may be selected based on the particular (e.g., optional) components implemented with an embodiment of the HVAC system 151. Indeed, certain HVAC systems 151 may have different embodiments of the power distribution enclosure 158 even though such HVAC systems 151 may use the same amount of electrical power provided by the power source 162. To this end, the same embodiment of the main drive line enclosure 152 may be configured to couple to any of multiple embodiments of the power distribution enclosure 158.

The illustrated electrical enclosure assembly 150 further includes a secondary enclosure 168 (e.g., an electrical enclosure, a third electrical enclosure) disposed within and/or supported by the main housing 148 and configured to house various other components of the HVAC system 151. Such components may also facilitate operation of the main drive line VSD 154 and may, for example, include additional circuitry 169 (e.g., a part of or an extension of the circuitry 160 of the power distribution enclosure 158), a filter 170 (e.g., a harmonic filter), an additional power conversion component 172, an additional control panel 173, another suitable component, or any combination thereof. The filter 170 may be electrically coupled to the components of the power distribution enclosure 158 (e.g., via the circuitry 160 and/or the additional circuitry 169) and may mitigate harmonics or fluctuation (e.g., voltage fluctuation) of the electrical power supplied by the power source 162 to the main drive line VSD 154, thereby improving the operation of the main drive line VSD 154. For instance, the filter 170 may receive the electrical power from the power source 162 via the additional circuitry 169, filter the electrical power, and provide the filtered electrical power to the circuitry 160 (e.g., to the power conversion component 164) for supply to the main drive line VSD 154. To this end, the secondary enclosure 168 may be physically coupled to the power distribution enclosure 158 via a second connector 174, which may have a channel or conduit through which the circuitry 160 is electrically coupled to the filter 170 to electrically couple the filter 170 and the main drive line VSDS 154 to one another. Although the secondary enclosure 168 is physically coupled to the power distribution enclosure 158 in the illustrated electrical enclosure assembly 150, the secondary enclosure 168 may additionally or alternatively be physically coupled to the main drive line enclosure 152 or physically coupled to neither the main drive line enclosure 152 nor the power distribution enclosure 158.

The additional power conversion component 172, which may include any of the components described with respect to the power conversion component 164, is configured to modify or condition electrical power (e.g., the electrical power received from the power source 162) for use by other components of the HVAC system 151. As an example, the additional power conversion component 172 may adjust the electrical power for supply to the control panel 44, to the additional control panel 173, to a VSD for another component (e.g., the condenser fan 62, an oil pump, a refrigerant pump, a cooling fluid pump, a conditioning fluid pump), to another suitable component of the HVAC system 151, or any combination thereof.

The additional control panel 173 may be accessible by a user to operate a component of the HVAC system 151. For example, the additional control panel 173 may enable a user to control operation of the HVAC system 151 from a location that is different than the location of the control panel 44, thereby increasing an accessibility and/or flexibility for the user in operating the HVAC system 151. In some embodiments, the additional control panel 173 may be used to operate another component of the secondary enclosure 168, such as the power conversion component 172. Additionally or alternatively, the additional control panel 173 may be configured to operate a component of the main drive line enclosure 152 and/or of the power distribution enclosure 158. For instance, the control panel 173 may be communicatively coupled to the main drive line VSD 154 and may be configured to output a control signal to cause the main drive line VSD to operate the motor 56. In further embodiments, the electrical enclosure assembly 150 may include one of the control panel 44 or the additional control panel 173 and not the other of the control panel 44 or the additional control panel 173.

In certain embodiments, different HVAC systems 151 may have a different set of components to be implemented in the secondary enclosure 168. Indeed, the secondary enclosure 168 may include any suitable quantity or type of the filter 170, the additional power conversion component 172, the additional control panel 173, or other electrical component, such as based on an attribute of the HVAC system 151 (e.g., an operating parameter of a component of the HVAC system 151) and/or by request from a user or customer. Accordingly, the secondary enclosure 168 may be of a variable embodiment and may be particularly manufactured or assembled such that HVAC systems 151 may have different embodiments of the secondary enclosure 168 even though such HVAC systems 151 may be of a similar size, have a similar input voltage, or another shared attribute. Indeed, the main drive line enclosure 152 and/or the power distribution enclosure 158 may be configured to couple to any of multiple embodiments of the secondary enclosure 168. Additionally, each of the secondary enclosures 168 may include a particularly manufactured additional control panel 173 that is configured to control the specific components of a corresponding secondary enclosure 168. Therefore, the additional control panel 173 enables control of the components of the secondary enclosure 168 without having to program, configure, or otherwise arrange the control panel 44 to control the components of the secondary enclosure 168. In this manner, the additional control panel 173 may reduce a complexity associated with manufacture of the electrical enclosure assembly 150.

Further, the main drive line enclosure 152, the power distribution enclosure 158, and the secondary enclosure 168 may include different components than illustrated herein. For instance, additional components may be included in any of the main drive line enclosure 152, the power distribution enclosure 158, and the secondary enclosure 168, and/or certain illustrated components may be in a different enclosure than depicted and/or may not be used by the HVAC system 151. Indeed, additional or alternative HVAC systems 151 may not have one of the power distribution enclosure 158 or the secondary enclosure 168. For example, the HVAC system 151 may not have the filter 170, the additional power conversion component 172, or the additional control panel 173, and/or such components may alternatively be disposed in the same enclosure with the circuitry 160, the power conversion component 164, and/or the switch 166 such that the HVAC system 151 may have the main drive line enclosure 152 and one additional enclosure. Indeed, the HVAC system 151 may have at least the main drive line enclosure 152, which may be of a common embodiment, and an additional enclosure, which may be of a variable embodiment.

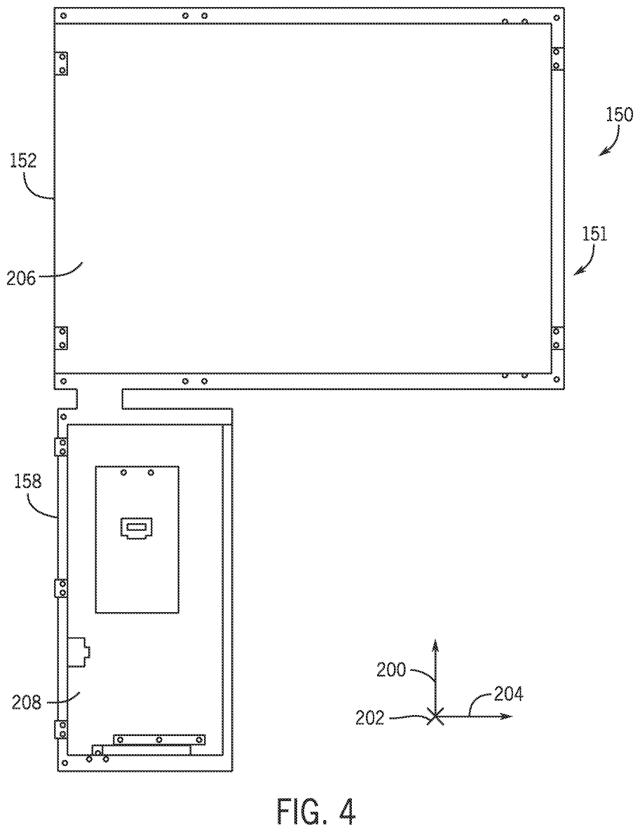

FIG. 4 is a front view of an embodiment of the electrical enclosure assembly 150 of the HVAC system 151. The main drive line enclosure 152 may be positioned offset relative to the power distribution enclosure 158 along a first axis 200 (e.g., a vertical axis). Furthermore, the secondary enclosure 168 (not shown) may be positioned offset relative to the main drive line enclosure 152 and/or the power distribution enclosure 158 along a second axis 202 (e.g., a longitudinal axis). However, in additional or alternative embodiments, the main drive line enclosure 152, the power distribution enclosure 158, and/or the secondary enclosure 168 may be positioned relative to one another in any suitable manner (e.g., offset along a third axis 204).

In some embodiments, the main drive line enclosure 152 may be adjustable to enable exposure of and/or access to components (e.g., the main drive line VSD 154, the cooling system 156) housed therein. For example, the main drive line enclosure 152 may include a first panel 206 that may be movable (e.g., rotatable, slidable) and/or removable in order to expose the components housed within the main drive line enclosure 152. Similarly, the power distribution enclosure 158 may also be adjustable to enable access to and/or exposure of components (e.g., the circuitry 160, the power conversion component 164, the I/O ports 165, the switch 166) housed therein, such as via a second panel 208 that may be adjustable relative to a remainder of the power distribution enclosure 158. In this manner, the first panel 206 and/or the second panel 208 may increase accessibility of certain components housed within the main drive line enclosure 152 and/or the power distribution enclosure 158, such as for maintenance, assembly, installation, adjustment, operation, and so forth, of the HVAC system 151.

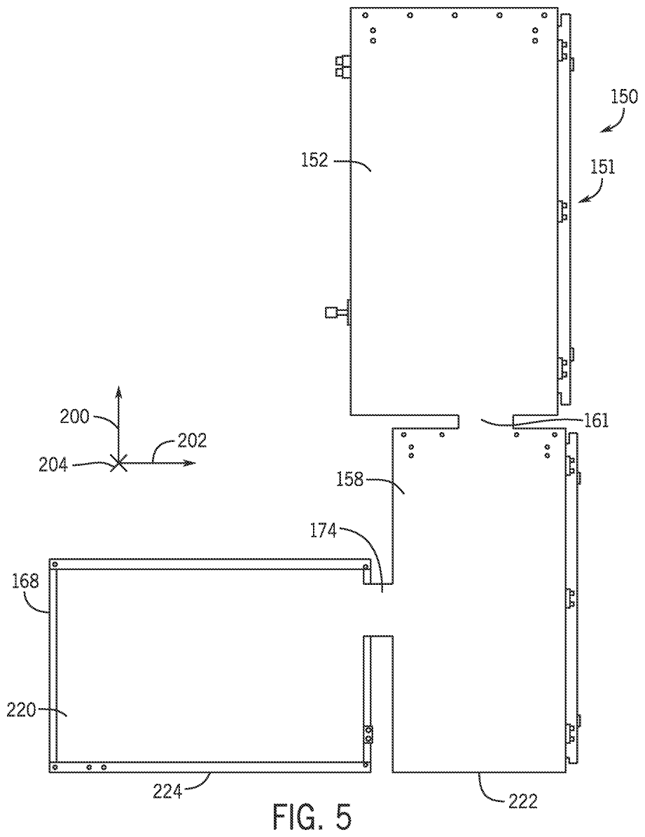

FIG. 5 is a side view of an embodiment of the electrical enclosure assembly 150 of the HVAC system 151. The secondary enclosure 168 is positioned offset relative to the main drive line enclosure 152 and the power distribution enclosure 158 along the second axis 202 in the illustrated embodiment. In certain embodiments, the secondary enclosure 168 may include a third panel 220 that may be adjustable to enable exposure of and/or access to components (e.g., the circuitry 169, the filter 170, the power conversion component 172) housed within the secondary enclosure 168, thereby increasing accessibility of such components.

In the illustrated embodiment, a first surface 222 of the power distribution enclosure 158 may be aligned with, planar to, or flush with a second surface 224 of the secondary enclosure 168. As such, in an installed configuration of the electrical enclosure assembly 150, the power distribution enclosure 158 and the secondary enclosure 168 may each be in contact with a base (e.g., the ground) to support the electrical enclosure assembly 150, including the main drive line enclosure 152. However, any combination of the enclosures 152, 158, 168 may support the electrical enclosure assembly 150 in additional or alternative embodiments. In further embodiments, any of the enclosures 152, 158, 168 may be mounted to another surface, such as a wall or panel. For instance, mounting one of the enclosures 152, 158, 168 to another support structure may increase securement and/or stability of the electrical enclosure assembly 150 in the installed configuration.

Further still, in certain embodiments, the enclosures 152, 158, 168 may be removably coupled to one another. By way of example, the first connector 161 coupling the main drive line enclosure 152 and the power distribution enclosure 158 to one another and/or the second connector 174 coupling the power distribution enclosure 158 and the secondary enclosure 168 to one another may be easily or readily detachable. As such, the first connector 161 and/or the second connector 174 may facilitate assembly and/or disassembly of the electrical enclosure assembly 150. For instance, it may be desirable to change, remove, replace, or otherwise modify one or more of the components, such as components that may vary between different embodiments of the HVAC system 151, incorporated in the HVAC system 151. As a result, a current one of the enclosures (e.g., the secondary enclosure 168) may be removed (e.g., by decoupling the secondary enclosure 168 from the power distribution enclosure 158), and a different embodiment of the enclosure (e.g., a different embodiment of the secondary enclosure 168) may be incorporated to accommodate the change in the components contained within the electrical enclosure assembly 150. Indeed, each of the enclosures 152, 158, 168 may be individually removable from the HVAC system 151 to accommodate incorporation of a different enclosure (e.g., a different embodiment of one of the enclosures 152, 158, 168). In this way, the connection between the main drive line enclosure 152, the power distribution enclosure 158, and the secondary enclosure 168 may facilitate modification of the electrical enclosure assembly 150 and the HVAC system 151.

Although the main drive line enclosure 152, the power distribution enclosure 158, and the secondary enclosure 168 have generally rectangular cross-sectional geometries in the illustrated embodiment, any of the enclosures 152, 158, 168 may have any suitable shape in additional or alternative embodiments, such as an oval cross-sectional geometry, a triangular cross-sectional geometry, an irregular polygonal shape, and/or any other suitable shape. Indeed, the cross-sectional shape of any of the enclosures 152, 158, 168 (e.g., of the secondary enclosure 168) may be different for different embodiments of the HVAC system 151 based on the particular components included therein.

While only certain features of present embodiments have been illustrated and described herein, many modifications and changes will occur to those skilled in the art. It is, therefore, to be noted that the appended claims are intended to cover all such modifications and changes that fall within the true spirit of the disclosure. Further, it should be noted that certain elements of the disclosed embodiments may be combined or exchanged with one another.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A heating, ventilation, and/or air conditioning (HVAC) system, comprising:
a first electrical enclosure comprising a main drive line variable speed drive (VSD) configured to drive operation of a compressor motor of the HVAC system; and
a second electrical enclosure comprising a power distribution component, wherein the power distribution component is configured to receive electrical power from a power source and to supply the electrical power to the main drive line VSD.

2. The HVAC system of claim 1, wherein the power distribution component comprises circuitry electrically coupling the power source to the main drive line VSD, a power conversion component configured to change a form of the electrical power received from the power source, or both.

3. The HVAC system of claim 1, wherein the second electrical enclosure comprises a switch configured to block the electrical power from being supplied to the main drive line VSD.

4. The HVAC system of claim 3, wherein the switch comprises a manual switch, a fuse, a circuit breaker, or any combination thereof.

5. The HVAC system of claim 1, wherein the second electrical enclosure is selected from a plurality of second electrical enclosure embodiments based on the main drive line VSD, a compressor of the HVAC system, the electrical power, or any combination thereof, and each second electrical enclosure embodiment of the plurality of second electrical enclosure embodiments is different from one another.

6. The HVAC system of claim 5, comprising a third electrical enclosure comprising a filter configured to couple to the power distribution component, a power conversion component configured to couple to the power distribution component, a control panel, or any combination thereof, configured to facilitate operation of the HVAC system.

7. The HVAC system of claim 7, wherein the third electrical enclosure is selected from a plurality of third electrical enclosure embodiments, and each third electrical enclosure embodiment of the plurality of third electrical enclosure embodiments is different from one another.

8. The HVAC system of claim 1, wherein the first electrical enclosure comprises a cooling system disposed therein and configured to cool the main drive line VSD.

9. The HVAC system 8, wherein the cooling system is configured to place the main drive line VSD in a heat exchange relationship with ambient air, a cooling liquid, or both to cool the main drive line VSD.

10. A heating, ventilation, and/or air conditioning (HVAC) system, comprising:
a first electrical enclosure comprising a main drive line variable speed drive (VSD) disposed therein and configured to operate a compressor motor of the HVAC system, wherein the first electrical enclosure is configured for implementation with different configurations of the HVAC system; and
a second electrical enclosure comprising a power distribution component configured to receive electrical power and to provide the electrical power to the main drive line VSD to enable operation of the main drive line VSD, wherein the second electrical enclosure is selected from a plurality of second enclosure embodiments.

11. The HVAC system of claim 10, wherein the power distribution component comprises a power conversion component configured to condition the electrical power for supply to the main drive line VSD.

12. The HVAC system of claim 10, comprising a third electrical enclosure comprising a control panel communicatively coupled to the main drive line VSD, wherein the control panel is configured to output a control signal to cause the main drive line VSD to operate the compressor motor.

13. The HVAC system of claim 12, wherein the third electrical enclosure comprises a power conversion component configured to condition the electrical power for supply to the control panel, to a fan of the HVAC system, to a pump of the HVAC system, or to any combination thereof.

14. The HVAC system of claim 13, wherein the power conversion component comprises a rectifier, an inverter, a transformer, a voltage regulator, a chopper, a converter, or any combination thereof.

15. The HVAC system of claim 12, wherein the control panel is configured to receive a user input, and the control panel is configured to output the control signal based on the user input.

16. A heating, ventilation, and/or air conditioning (HVAC) system, comprising:
a first electrical enclosure configured to enclose a main drive line variable speed drive (VSD) configured to drive operation of a compressor motor of the HVAC system;
a second electrical enclosure configured to enclose a power distribution component, wherein the power distribution component is configured to receive electrical power and to supply the electrical power to the main drive line VSD to operate the compressor motor; and
a third electrical enclosure configured to enclose a filter configured to filter the electrical power and mitigate harmonics of the electrical power before the electrical power is supplied to the main drive line VSD.

17. The HVAC system of claim 16, comprising the filter disposed within the third electrical enclosure, wherein the filter is configured to receive the electrical power, filter the electrical power, and provide filtered electrical power to the power distribution component for supply to the main drive line VSD.

18. The HVAC system of claim 16, comprising the power distribution component disposed within the second enclosure, wherein the first electrical enclosure is coupled to the second electrical enclosure via a first connector, and the power distribution component comprises circuitry configured to electrically couple a power source to the main drive line VSD and to supply the electrical power from the power source to the main drive line VSD via the first connector.

19. The HVAC system of claim 18, wherein the second electrical enclosure is coupled to the third electrical enclosure via a second connector, and the circuitry is configured to electrically couple the filter to the main drive line VSD via the second connector.

20. The HVAC system of claim 16, wherein the second electrical enclosure is configured to couple to any of a plurality of third electrical enclosure embodiments.
